(19) United States
(12) Patent Application Publication
(10) Pub. No.: US 2024/0330592 A1
(43) Pub. Date: Oct. 3, 2024

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Shotaro MISAWA, Tokyo (JP); Ryuji KANO, Tokyo (JP); Hirokazu YARIMIZU, Tokyo (JP); Tomoki TANIGUCHI, Tokyo (JP); Kohei ONODA, Tokyo (JP)

(21) Appl. No.: 18/596,629

(22) Filed: Mar. 6, 2024

(30) Foreign Application Priority Data
Mar. 31, 2023 (JP) 2023-058014

(51) Int. Cl. G06F 40/30; G06F 40/205

(52) U.S. Cl. CPC G06F 40/30; G06F 40/205

(57) ABSTRACT

An information processing apparatus generates a first character string set by dividing first document data into different lengths, derives an evaluation value of each character string constituting the first character string set by using the first character string set and second document data created from the first document data in accordance with a purpose, and selects, based on the derived evaluation value, a plurality of character strings from the first character string set as correct answer data of a generative model that receives input of document data and outputs a second character string set including a plurality of character strings included in the input document data.

### CROSS-REFERENCE TO RELATED APPLICATIONS

This application claims priority from Japanese Patent Application No. 2023-058014, filed on Mar. 31, 2023, the entire disclosure of which is incorporated herein by reference.

### BACKGROUND

### 1. Technical Field

The present disclosure relates to an information processing apparatus, an information processing method, and an information processing program.

### 2. Description of the Related Art

JP2019-121139A discloses a technology in which, in summarization apparatus that generates a summary from a document, the document is analyzed to generate document data, and a plurality of sentences having a high important score is extracted as important sentences from the generated document data.

### SUMMARY

For example, in a case in which a user performs a copy operation on a character string of the document data, the user selects a range of the character string to be copied. In this case, in a case in which the user designates a specific portion of the document data, such as a case in which the user brings a mouse cursor at a specific position of the document data, automatic selection of the range of the character string desired by the user is preferable in terms of supporting the operation of the user. That is, it is preferable to divide the document data at an appropriate division position desired by the user.

However, in the technology disclosed in JP2019-121139A, since the document data is divided in accordance with preset rules such as morphological analysis and syntax analysis, it may not be possible to divide the document data at an appropriate division position.

The present disclosure has been made in view of the above circumstances, and the present disclosure is to provide an information processing apparatus, an information processing method, and an information processing program which can divide document data at an appropriate division position.

The present disclosure relates to an information processing apparatus comprising: at least one processor, in which the processor acquires first document data, generates a first character string set by dividing the first document data into different lengths, derives an evaluation value of each character string constituting the first character string set by using the first character string set and second document data created from the first document data in accordance with a purpose, and selects, based on the derived evaluation value, a plurality of character strings from the first character string set as correct answer data of a generative model that receives input of document data and outputs a second character string set including a plurality of character strings included in the input document data.

In addition, the present disclosure relates to an information processing method including: via a processor provided in an information processing apparatus, acquiring first document data; generating a first character string set by dividing the first document data into different lengths; deriving an evaluation value of each character string constituting the first character string set by using the first character string set and second document data created from the first document data in accordance with a purpose; and selecting, based on the derived evaluation value, a plurality of character strings from the first character string set as correct answer data of a generative model that receives input of document data and outputs a second character string set including a plurality of character strings included in the input document data.

In addition, the present disclosure relates to an information processing program for causing a processor provided in an information processing apparatus to execute a process including: acquiring first document data; generating a first character string set by dividing the first document data into different lengths; deriving an evaluation value of each character string constituting the first character string set by using the first character string set and second document data created from the first document data in accordance with a purpose; and selecting, based on the derived evaluation value, a plurality of character strings from the first character string set as correct answer data of a generative model that receives input of document data and outputs a second character string set including a plurality of character strings included in the input document data.

In addition, the present disclosure relates to an information processing apparatus comprising: at least one processor, in which the processor acquires first document data, generates a character string set corresponding to the first document data by inputting the first document data to a generative model that receives input of document data and outputs a character string set including a plurality of character strings included in the input document data, and derives an evaluation value of the character string set as a reward in a case in which the generative model is trained through reinforcement learning, by using the generated character string set and second document data created from the first document data in accordance with a purpose.

In addition, the present disclosure relates to an information processing method including: via a processor provided in an information processing apparatus, acquiring first document data; generating a character string set corresponding to the first document data by inputting the first document data to a generative model that receives input of document data and outputs a character string set including a plurality of character strings included in the input document data; and deriving an evaluation value of the character string set as a reward in a case in which the generative model is trained through reinforcement learning, by using the generated character string set and second document data created from the first document data in accordance with a purpose.

In addition, the present disclosure relates to an information processing program for causing a processor provided in an information processing apparatus to execute a process including: acquiring first document data; generating a character string set corresponding to the first document data by inputting the first document data to a generative model that receives input of document data and outputs a character string set including a plurality of character strings included in the input document data; and deriving an evaluation value of the character string set as a reward in a case in which the generative model is trained through reinforcement learning, by using the generated character string set and second document data created from the first document data in accordance with a purpose.

According to the present disclosure, it is possible to divide the document data at an appropriate division position.

### BRIEF DESCRIPTION OF THE DRAWINGS

FIG. 1 is a block diagram showing an example of a hardware configuration of an information processing apparatus.

FIG. 2 is a diagram for describing a generative model.

FIG. 3 is a diagram for describing a generative model according to a modification example.

FIG. 4 is a diagram showing an example of first document data and second document data.

FIG. 5 is a block diagram showing an example of a functional configuration of an information processing apparatus in a training phase according to a first embodiment.

FIG. 6 is a diagram showing processing of generating a first character string set according to the first embodiment.

FIG. 7 is a diagram showing processing of deriving an evaluation value.

FIG. 8 is a flowchart showing an example of training processing according to the first embodiment.

FIG. 9 is a block diagram showing an example of a functional configuration of the information processing apparatus in an operation phase.

FIG. 10 is a diagram showing an example of a display screen.

FIG. 11 is a diagram showing an example of a display screen according to a modification example.

FIG. 12 is a diagram showing an example of the display screen according to the modification example.

FIG. 13 is a diagram showing an example of the display screen according to the modification example.

FIG. 14 is a diagram showing an example of the display screen according to the modification example.

FIG. 15 is a diagram showing an example of the display screen according to the modification example.

FIG. 16 is a flowchart showing an example of operation support processing.

FIG. 17 is a block diagram showing an example of a functional configuration of an information processing apparatus in a training phase according to a second embodiment.

FIG. 18 is a diagram showing processing of generating a first character string set according to the second embodiment.

FIG. 19 is a diagram for describing processing of selecting a character string.

FIG. 20 is a flowchart showing an example of training processing according to the second embodiment.

FIG. 21 is a block diagram showing an example of a functional configuration of an information processing apparatus in a training phase according to a third embodiment.

FIG. 22 is a flowchart showing an example of training processing according to the third embodiment.

FIG. 23 is a diagram for describing processing of presenting a character string set according to a modification example.

FIG. 24 is a diagram for describing a transformation model.

### DETAILED DESCRIPTION

Hereinafter, with reference to the accompanying drawings, an embodiment for performing the technology of the present disclosure will be described in detail.

### First Embodiment

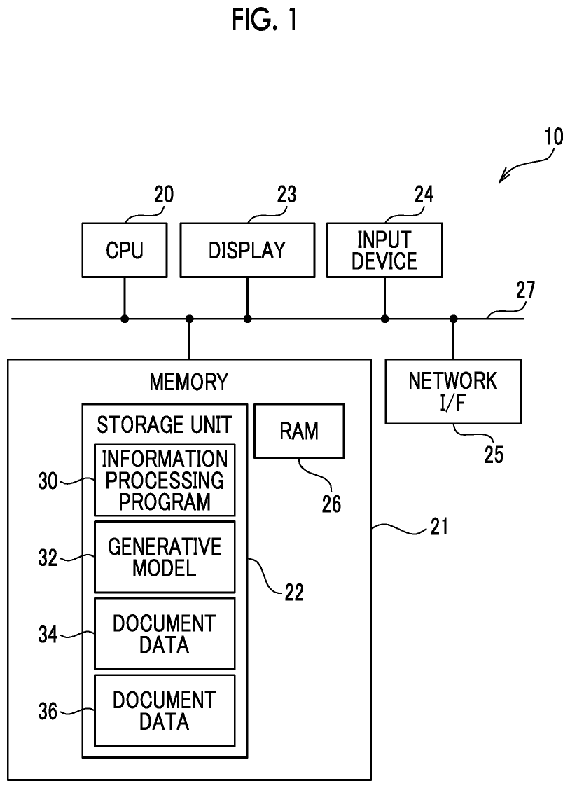

First, with reference to FIG. 1, a hardware configuration of an information processing apparatus 10 according to the present embodiment will be described. Examples of the information processing apparatus 10 include a computer, such as a personal computer or a server computer. As shown in FIG. 1, the information processing apparatus 10 includes a central processing unit (CPU) 20, a memory 21, a storage unit 22, a display 23, an input device 24, and a network interface (I/F) 25.

The CPU 20 realizes a functional configuration, which will be described below, by executing a program stored in the storage unit 22 described below. The CPU 20 is an example of a processor according to the technology of the present disclosure.

The memory 21 includes the storage unit 22 and a random access memory (RAM) 26. The RAM 26 is a memory for primary storage, and is, for example, a RAM, such as a static random access memory (SRAM) or a dynamic random access memory (DRAM).

The storage unit 22 is a non-volatile memory, and is realized by, for example, at least one of a hard disk drive (HDD), a solid state drive (SSD), or a flash memory. An information processing program 30 is stored in the storage unit 22 as a storage medium. The CPU 20 reads out the information processing program 30 from the storage unit 22, loads the readout information processing program 30 in the memory 21, and executes the loaded information processing program 30.

The storage unit 22 stores a generative model 32, document data 34, and document data 36. The document data 34 is an example of first document data according to the technology of the present disclosure, and the document data 36 is an example of second document data according to the technology of the present disclosure.

The display 23 is a device that displays various screens, and is, for example, a liquid crystal display or an electro luminescence (EL) display. The input device 24 is a device for a user to perform input, and is, for example, at least any of a keyboard, a mouse, a microphone for voice input, a touch pad for close contact input including contact, or a camera for gesture input. The network I/F 25 is an interface for connection to a network. A bus 27 connects the CPU 20, the memory 21, the storage unit 22, the display 23, the input device 24, and the network I/F 25 to each other.

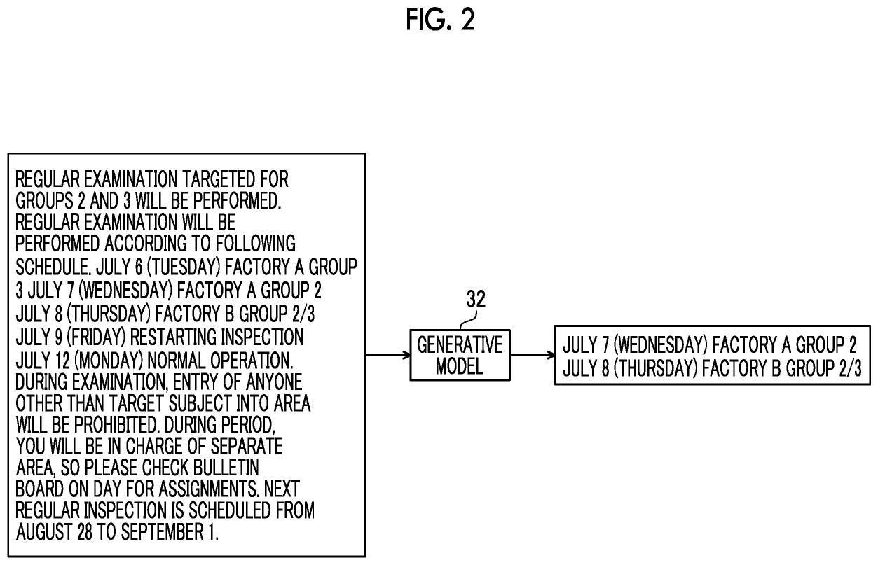

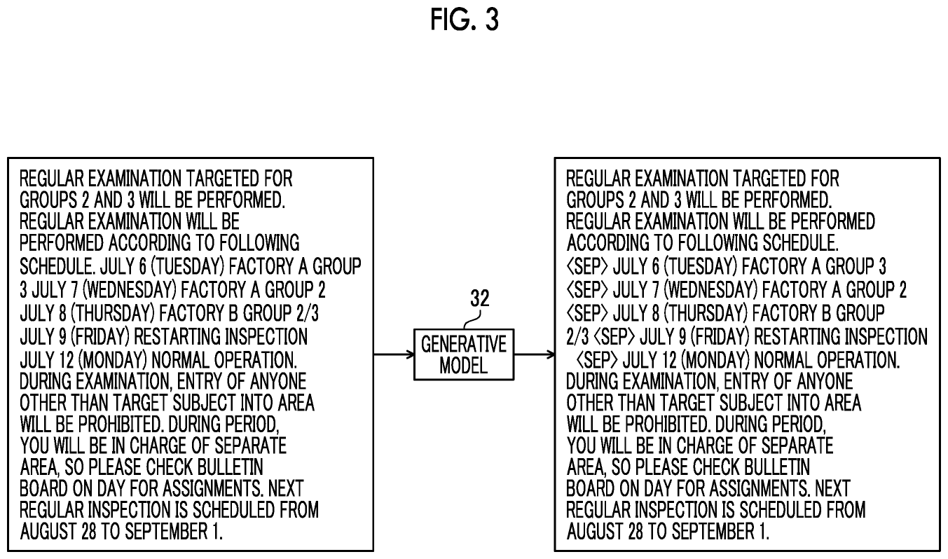

As shown in FIG. 2, the generative model 32 receives input of the document data and outputs a character string set including a plurality of character strings included in the input document data. In the present embodiment, a case will be described in which the generative model 32 outputs the character string set by extracting the plurality of different character strings from the input document data, but the technology of the present disclosure is not limited to this aspect. For example, as shown in FIG. 3, the generative model 32 may output the character string set including the plurality of different character strings divided at a division position by inserting a symbol (in the example in FIG. 3, <SEP>) representing the division position into the input document data. The generative model 32 is trained in a training phase described below so that the character string set divided at a desired division position is output. In this specification, “character string” may include at least one of an alphabet, a word, a sentence, an idiom, a phrase and a text.

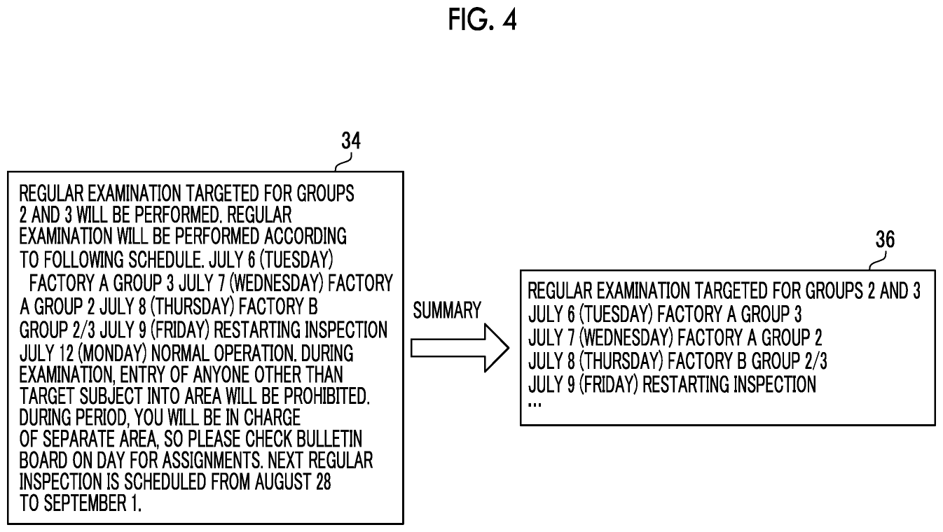

The document data 34 is document data of a source. As shown in FIG. 4, the document data 36 is document data created from the document data 34 in accordance with a purpose. In the present embodiment, the document data 36 is document data in which the document data 34 is summarized. The document data 36 is, for example, created by the user.

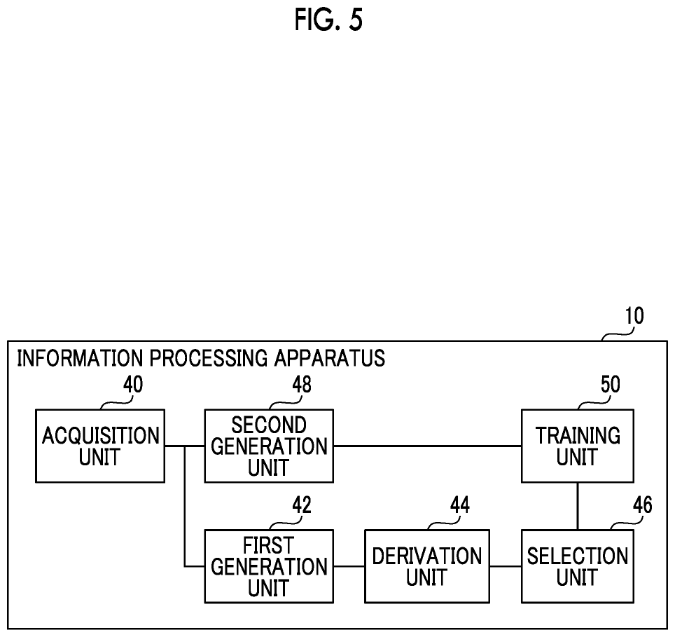

Hereinafter, a functional configuration of the information processing apparatus 10 in the training phase will be described with reference to FIG. 5. As shown in FIG. 5, the information processing apparatus 10 includes an acquisition unit 40, a first generation unit 42, a derivation unit 44, a selection unit 46, a second generation unit 48, and a training unit 50. The CPU 20 executes the information processing program 30, thereby functioning as the acquisition unit 40, the first generation unit 42, the derivation unit 44, the selection unit 46, the second generation unit 48, and the training unit 50.

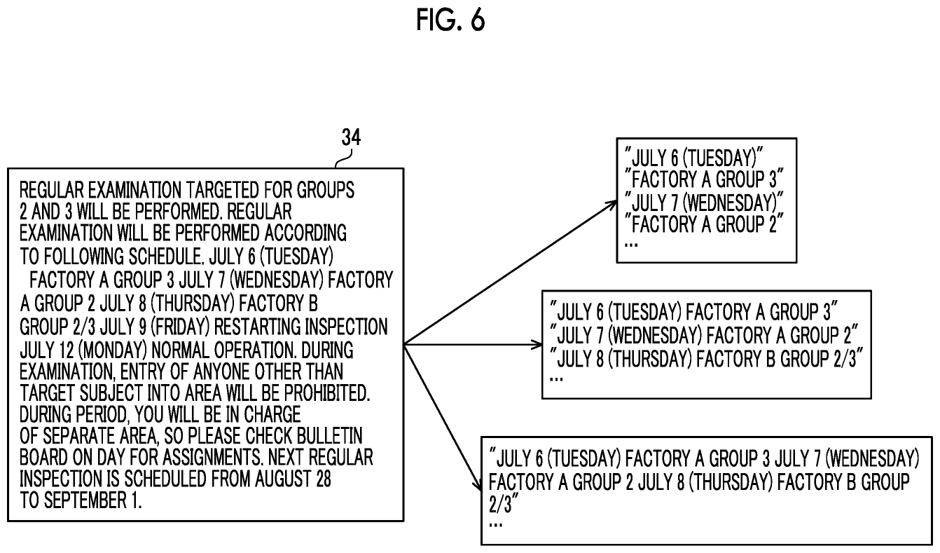

The acquisition unit 40 acquires the document data 34 from the storage unit 22. The first generation unit 42 generates a character string set (hereinafter, referred to as “first character string set”) by dividing the document data 34 into different lengths. As shown in FIG. 6, the first generation unit 42 according to the present embodiment generates a plurality of first character string sets by dividing the document data 34 into different lengths. Specifically, the first generation unit 42 generates the plurality of first character string sets by dividing the document data 34 into units having different lengths, for example, one word or three words. That is, the character strings included in one first character string set do not have overlapping portions. In addition, the character strings included in the first character string set A and the character strings included in the first character string set B have overlapping portions, but the lengths of the character strings are different from each other.

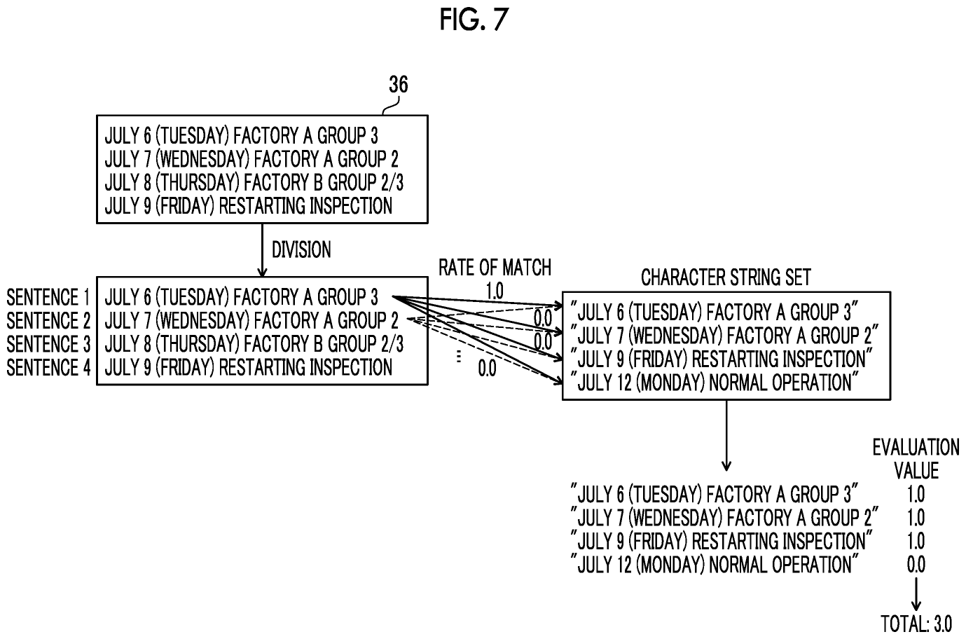

The derivation unit 44 derives the evaluation value of each character string constituting the first character string set by using the first character string set generated by the first generation unit 42, and the document data 36. Specifically, as shown in FIG. 7, the derivation unit 44 divides the document data 36 into sentences, and derives the maximum value of a rate of match of each sentence included in the document data 36 for the character string constituting the first character string set, as the evaluation value of the character string. That is, this evaluation value is a value of which the evaluation is higher as the rate of match between each character string constituting the first character string set and the document data 36 is higher. Examples of the rate of match include an editing distance, a bilingual evaluation understudy (BLEU) score, a recall-oriented understudy for gisting evaluation (ROUGE) score, and a bidirectional encoder representations from transformers (BERT) score. Moreover, the derivation unit 44 derives a total value of the evaluation values of the character strings constituting the first character string set as the evaluation value of the first character string set.

The selection unit 46 selects any one of the plurality of first character string sets generated by the first generation unit 42 as correct answer data of the generative model 32 based on the evaluation value derived by the derivation unit 44. In the present embodiment, the selection unit 46 selects, as the correct answer data of the generative model 32, the character string set of which the evaluation value derived by the derivation unit 44 is the largest among the plurality of first character string sets generated by the first generation unit 42.

It should be noted that the evaluation value of the first character string set may be a value of which the evaluation is higher as each character string constituting the first character string set is longer. For example, the derivation unit 44 may derive a new evaluation value of the first character string set by dividing the evaluation value of the first character string set derived as described above by the number of character strings included in the first character string set. The number of character strings included in the first character string set is a value smaller as each character string constituting the first character string set is longer. As described above, the derivation unit 44 may set the evaluation value to a value larger as each character string constituting the first character string set is longer, by performing the division by the number of character strings. In addition, the derivation unit 44 may set the evaluation value to a value larger as the number of characters constituting the character string is larger. The derivation unit 44 may derive the evaluation value by providing a reference number of characters and taking off the point in accordance with a difference between the number of characters constituting the character string and the reference number of characters. In addition, the generative model 32 may be prepared for each different reference number of characters. In this case, the derivation unit 44 selects the generative model 32 corresponding to the reference number of characters closest to the number of characters in the past selection history of the user. The number of characters in the selection history in this case may be a statistical value, such as an average value or a median value.

In addition, as the evaluation value of each character string constituting the first character string set, at least one of the accuracy or the reproducibility for each sentence of the document data 36 may be used. Here, the accuracy is an index value indicating how much the content of the character string constituting the first character string set is covered by the sentence of the document data 36. Here, the reproducibility is an index value indicating how much the content of the sentence of the document data 36 is covered by the character string constituting the first character string set.

The second generation unit 48 generates a character string set (hereinafter, referred to as “second character string set”) corresponding to the document data 34 by inputting the document data 34 acquired by the acquisition unit 40 to the generative model 32.

The training unit 50 trains the generative model 32 so that an error between the second character string set generated by the second generation unit 48 and the first character string set selected by the selection unit 46 is minimized.

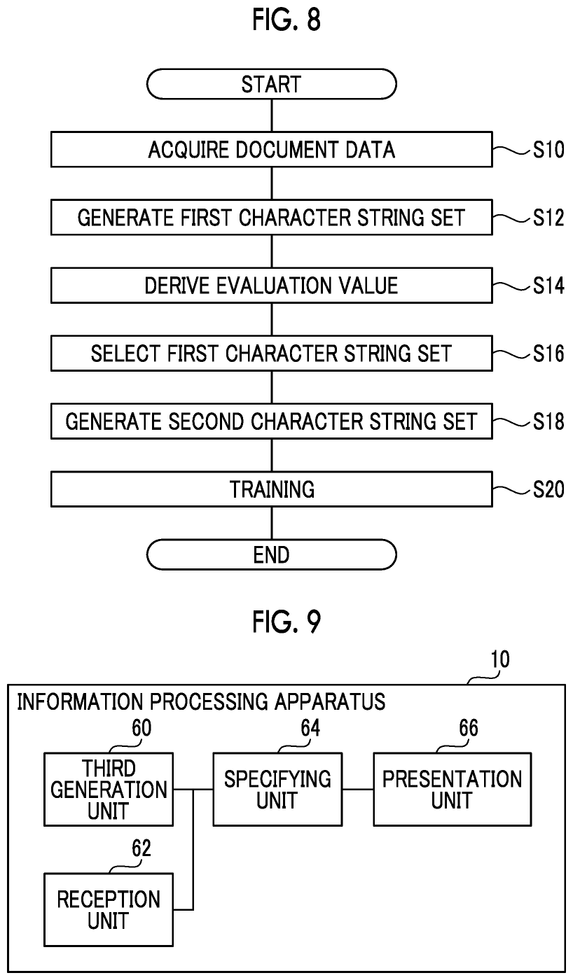

Hereinafter, actions of the information processing apparatus 10 in the training phase will be described with reference to FIG. 8. In a case in which the CPU 20 executes the information processing program 30, training processing shown in FIG. 8 is executed. The training processing shown in FIG. 8 is executed, for example, in a case in which an instruction to start execution is input by the user.

In step S10 in FIG. 8, the acquisition unit 40 acquires the document data 34 from the storage unit 22. In step S12, the first generation unit 42 generates the first character string set by dividing the document data 34 acquired in step S10 into different lengths, as described above.

In step S14, as described above, the derivation unit 44 derives the evaluation value of each character string constituting the first character string set by using the first character string set generated in step S12, and the document data 36. The derivation unit 44 derives the total value of the derived evaluation values as the evaluation value of the first character string set.

In step S16, the selection unit 46 selects any one of the plurality of first character string sets generated in step S12 as the correct answer data of the generative model 32 based on the evaluation value derived in step S14, as described above.

In step S18, the second generation unit 48 generates the second character string set corresponding to the document data 34 by inputting the document data 34 acquired in step S10 to the generative model 32. In step S20, the training unit 50 trains the generative model 32 so that the error between the second character string set generated in step S18 and the first character string set selected in step S16 is minimized. In a case in which the processing in step S20 ends, the training processing ends. The accuracy of the generative model 32 is improved by executing the training processing for each of the combinations of the plurality of different document data 34 and the document data 36.

Hereinafter, a functional configuration of the information processing apparatus 10 in an operation phase will be described with reference to FIG. 9. As shown in FIG. 9, the information processing apparatus 10 includes a third generation unit 60, a reception unit 62, a specifying unit 64, and a presentation unit 66. The CPU 20 executes the information processing program 30, thereby functioning as the third generation unit 60, the reception unit 62, the specifying unit 64, and the presentation unit 66.

The third generation unit 60 generates the character string set by inputting the document data as a processing target to the generative model 32. The document data as the processing target is, for example, document data being referred to by the user.

The reception unit 62 receives the position in the document data designated by the user. The user designates a predetermined position in the document data by, for example, an operation of bringing a mouse cursor to the predetermined position of the document data, an operation of clicking the predetermined position of the document data, and the like.

The specifying unit 64 specifies the character string described at the position received by the reception unit 62 from among the character strings included in the character string set generated by the third generation unit 60.

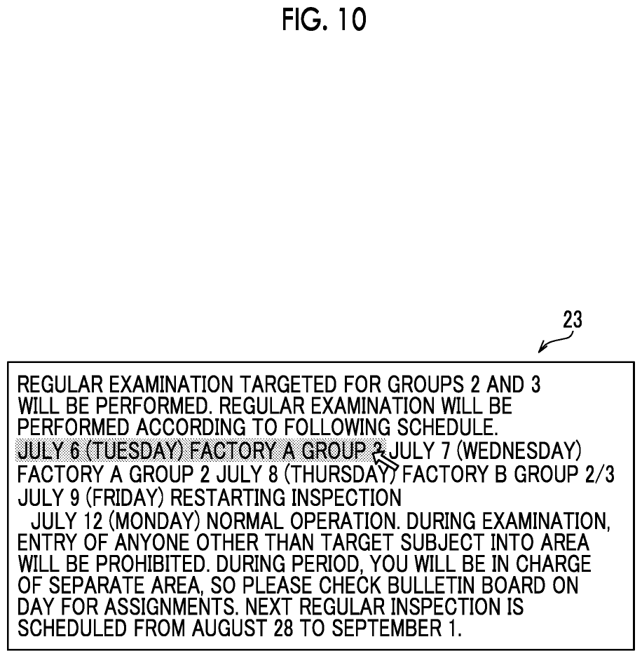

The presentation unit 66 presents the character string specified by the specifying unit 64 to the user. As shown in FIG. 10 as an example, the presentation unit 66 presents the character string to the user by setting the document data displayed on the display 23 to a state in which the character string specified by the specifying unit 64 is range-selected. As a result, it is possible to reduce the time and effort of the operation of selecting the character string in a case of a copy operation by the user. In addition, since the character string in this case is generated by the generative model 32 trained in the training phase described above, and the division is performed at an appropriate division position. Therefore, it is possible to effectively support the operation of the user.

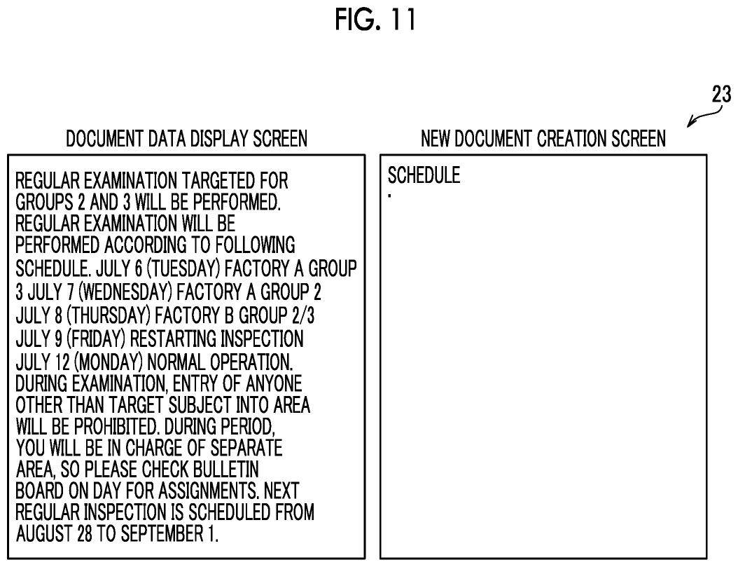

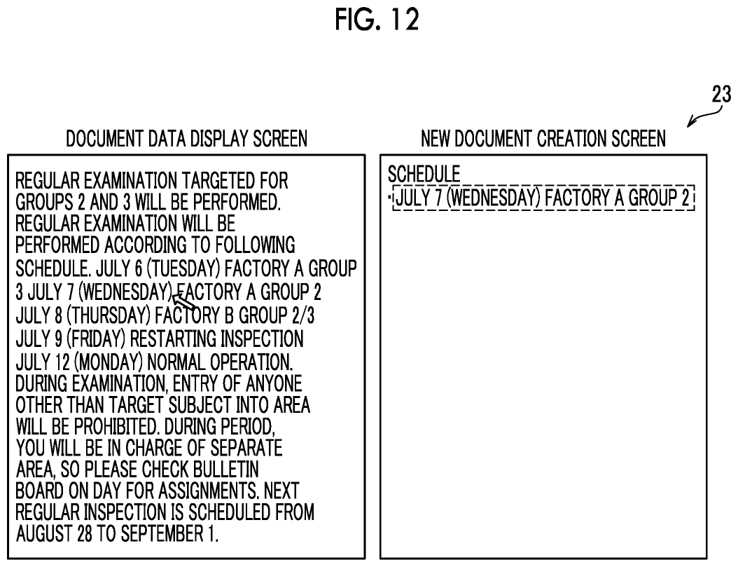

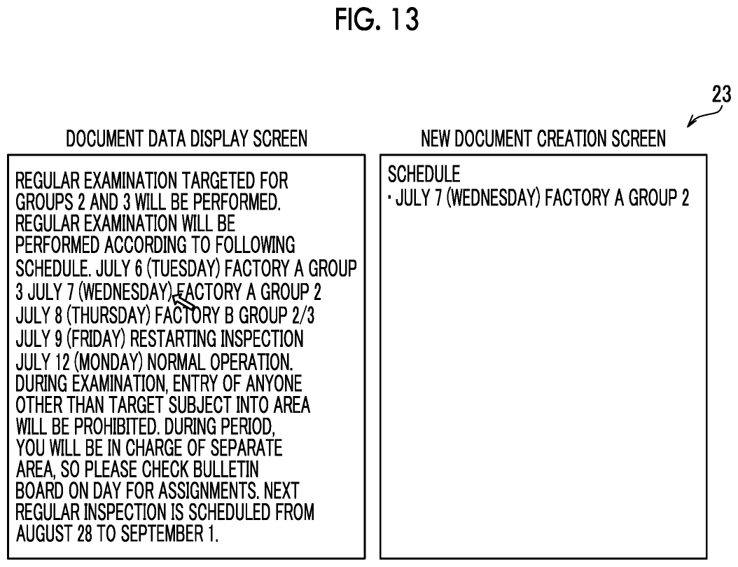

It should be noted that the example has been described in which the presentation unit 66 presents the character string specified on the document data to the user by performing the display in which the specified character string is relatively emphasized with respect to the other character strings, but the technology of the present disclosure is not limited to this aspect. For example, the presentation unit 66 may display the specified character string in a display frame different from the document data, such as pop-up display. Further, in a case in which a display screen of the document data is designated on a screen on which the display screen of the document data and a new document creation screen of a summary document or the like are displayed, the presentation unit 66 may make the specified character string be described on the new document creation screen. For example, as shown in FIG. 11, in a case in which the display screen including the document data display screen for displaying the document data and the new document creation screen for creating the new document of the summary document or the like is presented, and the designation of the position by a pointer or the like is received on the document data display screen, the presentation unit 66 presents the specified character string described at the position on the new document creation screen as an editable character string as shown in FIG. 12. As shown in FIG. 13, the presentation unit 66 may store the selected character string as a part of the new document by receiving the decision selection by the user via the input device 24. It should be noted that the examples of FIGS. 12 and 13 show the display aspect in which the editable character string in the new document creation screen is surrounded by a broken line, and the display aspect in which the decided character string is not surrounded by a broken line. However, the display aspect is not limited to these examples as long as the editable character string and the decided character string can be distinguished from each other.

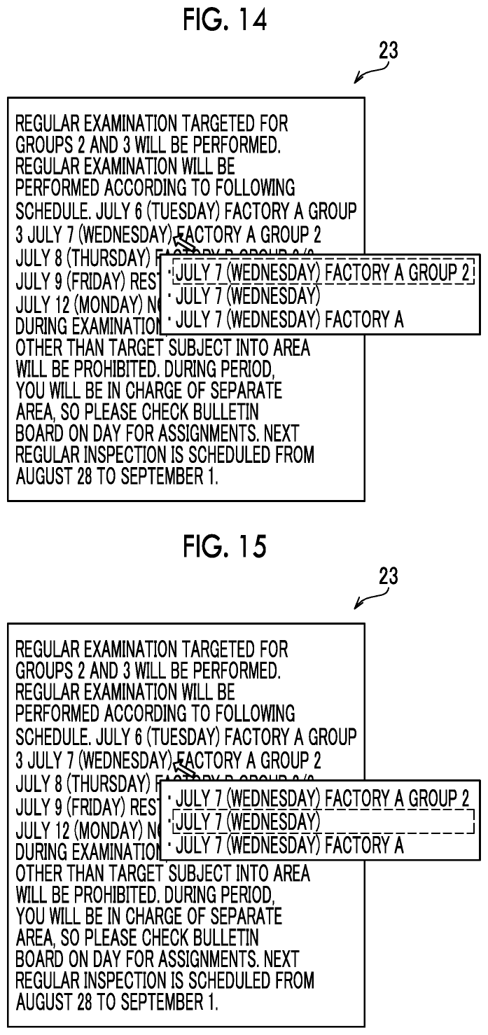

The generative model 32 may output a plurality of different division position candidates and a certainty of each of the plurality of division position candidates. For example, the generative model 32 may output a certainty of 90% for “July 7 (Wednesday) factory A group 2”, a certainty of 70% for “July 7 (Wednesday)”, and a certainty of 50% for “July 7 (Wednesday) factory A”. In addition, the third generation unit 60 may have a plurality of generative models 32 in which the conditions, such as the weighting for the seed or the length of the character string of the dividing target in a case of generating the training data are changed, and may output a plurality of different division position candidates for each generative model 32. In this case, the specifying unit 64 specifies a plurality of different character strings in accordance with the position designated by the user. The presentation unit 66 may present the plurality of different character strings specified by the specifying unit 64 to the user. For example, as shown in FIGS. 14 and 15, the presentation unit 66 presents the plurality of specified character strings having different lengths to the user. In this case, the presentation unit 66 may present the specific character string corresponding to the division position candidate derived by the generative model 32 having the highest priority or the division position candidate having the highest certainty, in a selected state, and receive a switching operation by the user, such as the click operation of the mouse, thereby enabling the selection of the specified character string corresponding to the division position candidate different from the selected division position candidate. It should be noted that the selection of the character string includes copying the character string and reflecting the character string to the summary document by a paste operation to the summary document, and reflecting the character string to the summary document in an editable state. In the examples of FIGS. 14 and 15, the display aspect has been shown in which the plurality of specified different character strings are presented by a pop-up window, but the display aspect is not limited to this example. In addition, in the examples of FIGS. 14 and 15, the display aspect has been shown in which the selected character string is surrounded by a broken line, but the display aspect is not limited to this example as long as the selected character string and the unselected character string can be distinguished from each other.

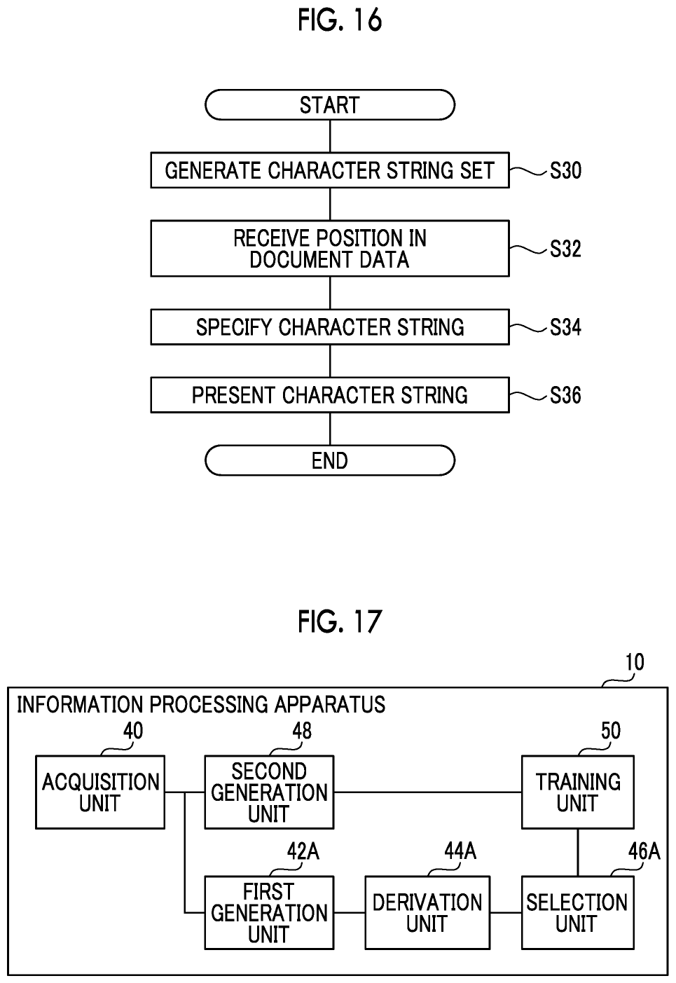

Hereinafter, actions of the information processing apparatus 10 in the operation phase will be described with reference to FIG. 16. In a case in which the CPU 20 executes the information processing program 30, operation support processing shown in FIG. 16 is executed. The operation support processing shown in FIG. 16 is executed on the document data as the processing target, for example, in a case in which an operation of the user, such as double-clicking the document data, is performed to open a file of the document data.

In step S30 in FIG. 16, the third generation unit 60 inputs the document data as the processing target to the generative model 32, to generate the character string set. In step S32, the reception unit 62 receives the position in the document data designated by the user.

In step S34, the specifying unit 64 specifies the character string described at the position received in step S32 from among the character strings included in the character string set generated in step S30. In step S36, the presentation unit 66 presents the character string specified in step S34 to the user, as described above. In a case in which the processing of step S36 ends, the operation support processing ends.

As described above, according to the present embodiment, it is possible to divide the document data at the appropriate division position. As a result, it is possible to effectively support the operation of the user.

### Second Embodiment

A second embodiment of the technology of the present disclosure will be described. It should be noted that the hardware configuration of the information processing apparatus 10 according to the present embodiment is the same as the configuration in the first embodiment, and thus the description thereof will be omitted.

A functional configuration of the information processing apparatus 10 in the training phase will be described with reference to FIG. 17. The functional units having the same functions as the information processing apparatus 10 according to the first embodiment are denoted by the same reference numerals, and the description thereof will be omitted. As shown in FIG. 17, the information processing apparatus 10 includes the acquisition unit 40, a first generation unit 42A, a derivation unit 44A, a selection unit 46A, the second generation unit 48, and the training unit 50. The CPU 20 executes the information processing program 30, thereby functioning as the acquisition unit 40, the first generation unit 42A, the derivation unit 44A, the selection unit 46A, the second generation unit 48, and the training unit 50.

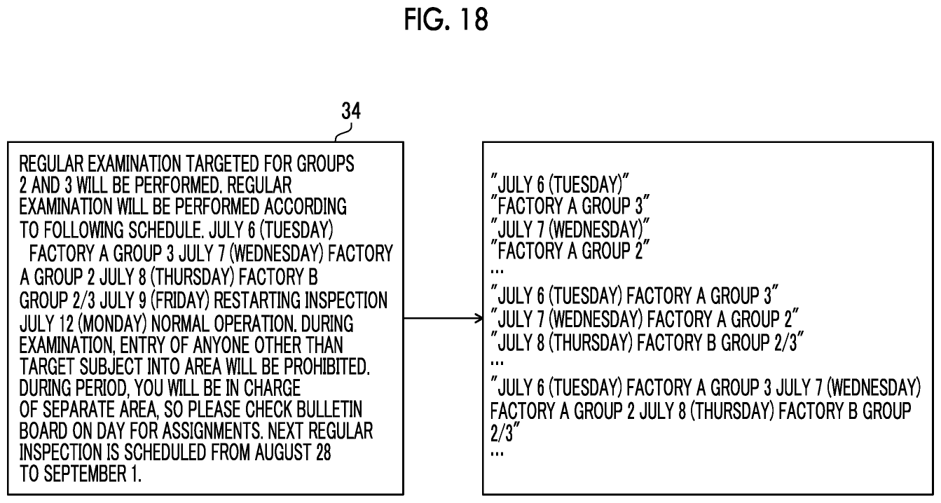

The first generation unit 42A generates the first character string set by dividing the document data 34 into different lengths. As shown in FIG. 18, the first generation unit 42A according to the present embodiment generates one first character string set by repeatedly performing the processing of dividing the document data 34 while varying the length of the division. Specifically, the first generation unit 42A generates one first character string set by repeatedly performing processing of dividing the document data 34 into units of a certain length, such as processing of dividing the document data 34 into one word and processing of dividing the document data 34 into three words, while varying the length. That is, the character string included in one first character string set includes character strings having overlapping portions and different lengths.

The derivation unit 44A derives the evaluation value of each character string constituting the first character string set by using the first character string set generated by the first generation unit 42A, and the document data 36. Since this processing of deriving the evaluation value is the same as the processing in the first embodiment, the description thereof will be omitted.

The selection unit 46A selects, as the correct answer data of the generative model 32, the plurality of character strings from the first character string set generated by the first generation unit 42A based on the evaluation value derived by the derivation unit 44A in a state in which there is no overlapping portion between the plurality of character strings.

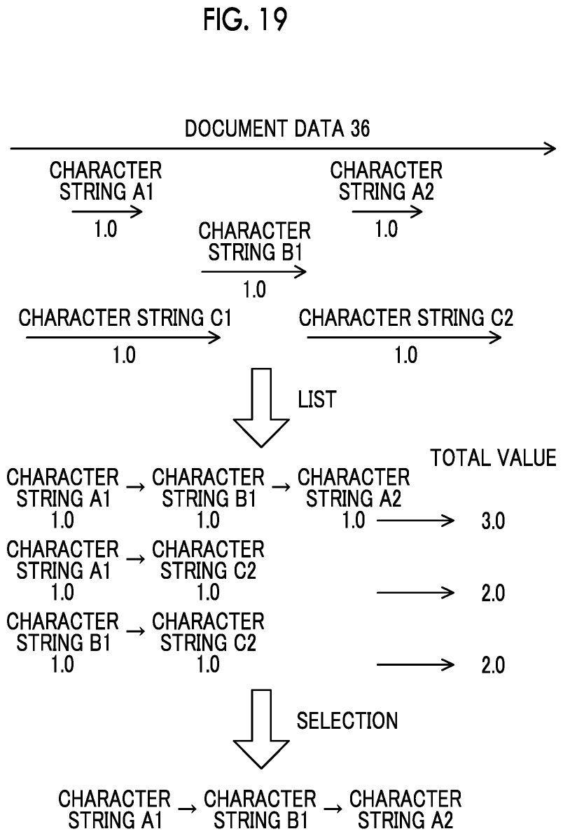

Specifically, as shown in FIG. 19, first, the selection unit 46A lists the combinations of the plurality of character strings having no overlapping portions from the first character string set generated by the first generation unit 42A. FIG. 19 shows an example in which the character strings included in the first character string set are divided into three stages of short, intermediate, and long. Character strings A1 and A2 in FIG. 19 indicate character strings divided by the shortest length among the three stages, a character string B1 indicates a character string divided by an intermediate length among the three stages, and character strings C1 and C2 indicate character strings divided by the longest length among the three stages. An arrow under each character string in FIG. 19 indicates a description position of the character string in the document data 36, and a length of the arrow indicates a length of the character string. In addition, a numerical value under the arrow under each character string in FIG. 19 indicates the evaluation value derived by the derivation unit 44A for the character string.

Hereinafter, the selection unit 46A derives the total value of the evaluation values of the character strings for each of the listed combinations of the plurality of character strings. Then, the selection unit 46A selects the plurality of character strings of the combination of which the derived total value is the largest as the correct answer data of the generative model 32.

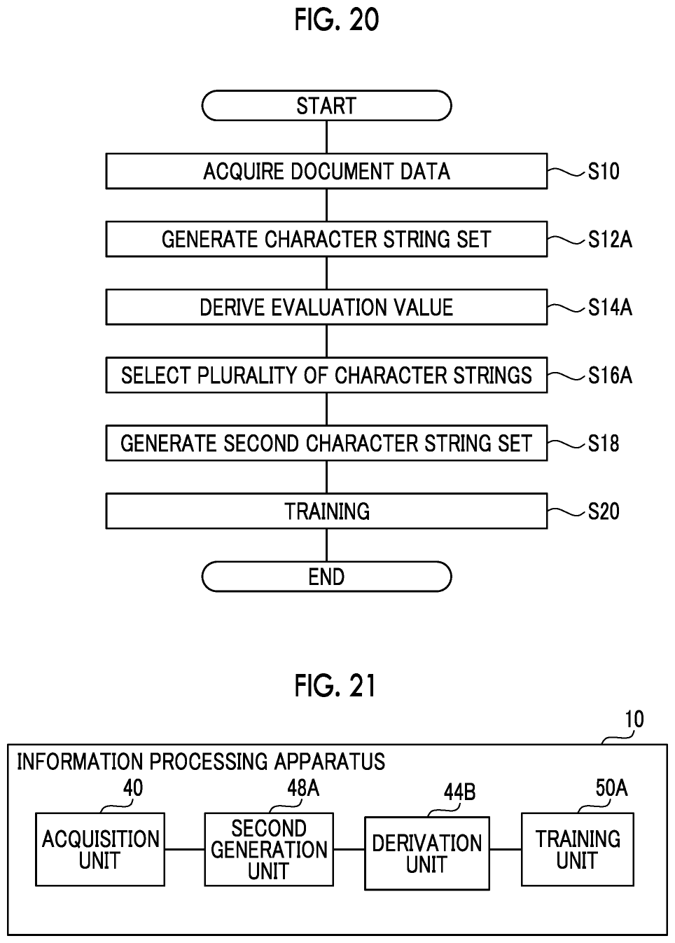

Hereinafter, actions of the information processing apparatus 10 in the training phase will be described with reference to FIG. 20. In a case in which the CPU 20 executes the information processing program 30, training processing shown in FIG. 20 is executed. The training processing shown in FIG. 20 is executed, for example, in a case in which an instruction to start execution is input by the user. The steps in FIG. 20 for executing the same processing as FIG. 8 will be denoted by the same step numbers, and the description thereof will be omitted.

Steps S12A, S14A, and S16A in FIG. 20 are executed instead of steps S12, S14, and S16 in FIG. 8. In step S12A, the first generation unit 42A generates the first character string set by dividing the document data 34 into different lengths, as described above.

In step S14A, the derivation unit 44A derives the evaluation value of each character string constituting the first character string set by using the first character string set generated in step S12A, and the document data 36. In step S16A, as described above, the selection unit 46A selects the plurality of character strings from the first character string set generated by the first generation unit 42A as the correct answer data of the generative model 32 based on the evaluation value derived in step S14A in a state in which there is no overlapping portion between the plurality of character strings.

Since the functional configuration and the actions of the information processing apparatus 10 in the operation phase are the same as the functional configuration and the actions in the first embodiment, the description thereof will be omitted.

As described above, according to the present embodiment, it is possible to obtain the same effect as the effect of the first embodiment.

### Third Embodiment

A third embodiment of the technology of the disclosure will be described. It should be noted that the hardware configuration of the information processing apparatus 10 according to the present embodiment is the same as the configuration in the first embodiment, and thus the description thereof will be omitted. In the present embodiment, the information processing apparatus 10 trains the generative model 32 through reinforcement learning.

A functional configuration of the information processing apparatus 10 in the training phase will be described with reference to FIG. 21. The functional units having the same functions as the information processing apparatus 10 according to the first embodiment are denoted by the same reference numerals, and the description thereof will be omitted. As shown in FIG. 21, the information processing apparatus 10 includes the acquisition unit 40, a derivation unit 44B, a second generation unit 48A, and a training unit 50A. The CPU 20 executes the information processing program 30, thereby functioning as the acquisition unit 40, the derivation unit 44B, the second generation unit 48A, and the training unit 50A.

The second generation unit 48A inputs the document data 34 acquired by the acquisition unit 40 to the generative model 32, to generate the character string set corresponding to the document data 34.

The derivation unit 44B derives the evaluation value of each character string constituting the character string set by using the character string set generated by the second generation unit 48A, and the document data 36. Since this processing of deriving the evaluation value is the same as the processing in the first embodiment, the description thereof will be omitted. Moreover, the derivation unit 44B derives the total value of the evaluation values of the character strings constituting the character string set as the evaluation value of the character string set. The derivation unit 44B derives the evaluation value of the character string set as a reward in a case of training the generative model 32 through the reinforcement learning.

The training unit 50A performs trains the generative model 32 through the reinforcement learning by using the evaluation value derived by the derivation unit 44B as the reward.

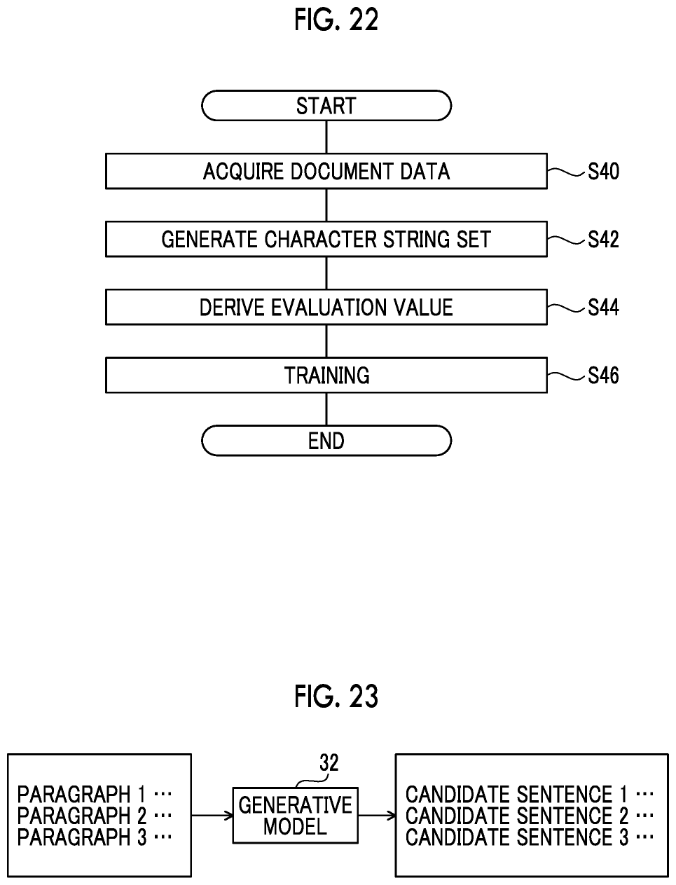

Hereinafter, actions of the information processing apparatus 10 in the training phase will be described with reference to FIG. 22. In a case in which the CPU 20 executes the information processing program 30, training processing shown in FIG. 22 is executed. The training processing shown in FIG. 22 is executed, for example, in a case in which an instruction to start execution is input by the user.

In step S40 in FIG. 22, the acquisition unit 40 acquires the document data 34 from the storage unit 22. In step S42, the second generation unit 48A generates the character string set corresponding to the document data 34 by inputting the document data 34 acquired in step S40 to the generative model 32.

In step S44, the derivation unit 44B derives the evaluation value of each character string constituting the character string set by using the character string set generated by the second generation unit 48A, and the document data 36. Further, the derivation unit 44B derives the total value of the derived evaluation values as the evaluation value of the character string set. In step S46, the training unit 50A trains the generative model 32 through the reinforcement learning by using the evaluation value derived in step S44 as the reward. In a case in which the processing in step S46 ends, the training processing ends.

Since the functional configuration and the actions of the information processing apparatus 10 in the operation phase are the same as the functional configuration and the actions in the first embodiment, the description thereof will be omitted.

As described above, according to the present embodiment, it is possible to obtain the same effect as the effect of the first embodiment.

It should be noted that, in the first embodiment, the derivation unit 44 may decrease the evaluation value of the derived first character string set in accordance with at least one of a quantity of the character strings (hereinafter, referred to as “over-extraction character strings”) that are included in the first character string set but not included in the document data 36 or a quantity of the character strings (hereinafter, referred to as “shortage character strings”) that are included in the document data 36 but not included in the first character string set. In this case, for example, the derivation unit 44 decreases the evaluation value of the first character string set by a larger quantity as the quantity of these character strings is larger. Examples of the quantity of the character string include the number of character strings and a total number of characters in the character strings. In the example in FIG. 7, “July 8 (Thursday) Factory B Group 2/3” corresponds to the shortage character string, and “July 12 (Monday) Normal operation” corresponds to the over-extraction character string.

Similarly, in the third embodiment, the derivation unit 44B may decrease the evaluation value of the character string set derived in accordance with at least one of the quantity of the over-extraction character strings that are included in the character string set but not included in the document data 36 or the quantity of the shortage character strings that are included in the document data 36 but not included in the character string set.

In this way, by training the generative model 32 to exclude a part of the over-extraction from the document data 34 instead of completely excluding the over-extraction, it is possible to divide the document data at an appropriate division position.

In addition, in a case in which the CPU 20 presents a candidate sentence for the summary document data from the document data 34 corresponding to the medical document, such as the electronic medical record, by using the generative model 32, the selection of the candidate sentence by the user is hindered in a case in which the quantity of the over-extraction character string is too large, and thus the over-extraction character string may be excluded.

In addition, as a modification example of the operation phase, as shown in FIG. 23, the presentation unit 66 may present, to the user, the character string set generated by inputting the document data as the processing target to the generative model 32 as the candidate sentence from the summary document data in which the document data as the processing target is summarized. In this case, the user can create the summary document data by selecting the presented candidate sentence.

In this embodiment, the plurality of generative models 32 may be prepared. For example, the plurality of generative models 32 that have been trained by varying a decrease width of the evaluation value of the character string set in accordance with the quantity of the over-extraction character string may be prepared. Specifically, for example, the first generative model 32 is a model that has been trained by using the character string set selected based on the evaluation value decreased by 5% for each increase in the number of the over-extraction character strings by one. In addition, for example, the second generative model 32 is a model that has been trained by using the character string set selected based on the evaluation value decreased by 10% for each increase in the number of the over-extraction character strings by one. That is, the tolerance to the over-extraction is different for each generative model 32.

In this case, the CPU 20 may switch the generative model 32 in accordance with the selection history of the user for the candidate sentence for the summary document data presented by using the generative model 32. For example, the CPU 20 may switch the generative model 32 so that the generative model 32 having a lower tolerance to over-extraction is used as a degree of non-selection of the candidate sentence by the user is higher in the candidate sentence for the summary document data. Examples of the degree of non-selection include “the number of non-selected character strings/the number of candidate sentences” and “the number of selected character strings/the number of candidate sentences”.

In addition, in this case, in a case in which the degree of non-selection of the candidate sentence by the user is equal to or larger than a certain degree, the CPU 20 may retrain the generative model 32 by using the candidate sentence selected by the user as the correct answer data.

In the second embodiment, in the processing of deriving the evaluation value of the character string, the derivation unit 44A may derive an F score such as an ROUGE-F score as the evaluation value, may use Precision as a penalty, or may reduce the penalty by setting Precision as a magnification equal to or larger than 0 and smaller than 1 in the calculation of the F score.

In addition, in each of the embodiments described above, the evaluation values of the character strings included in the character string set may be changed by the derivation units 44, 44A, and 44B in accordance with the past operation tendency of the user. For example, the derivation units 44, 44A, and 44B may derive the evaluation value so that, as the length in a case in which the user selects the character string is longer, the evaluation of the long character string is higher, based on the past operation history of the user. As the length in a case in which the user selects the character string in this case, the statistical value, such as the average value or the median value, may be used. In addition, the evaluation value may be derived by setting the statistical value of the length in a case in which the user selects the character string as the reference number of characters and taking off the point in accordance with the difference from the reference number of characters. In addition, a plurality of models having different reference numbers of characters may be prepared in advance, and the models may be switched based on the statistical value of the length in a case in which the user selects the character string.

In addition, in each of the embodiments described above, in a case in which the rate of match between the character strings is equal to or smaller than a certain value, the derivation units 44, 44A, and 44B may set the rate of match to zero.

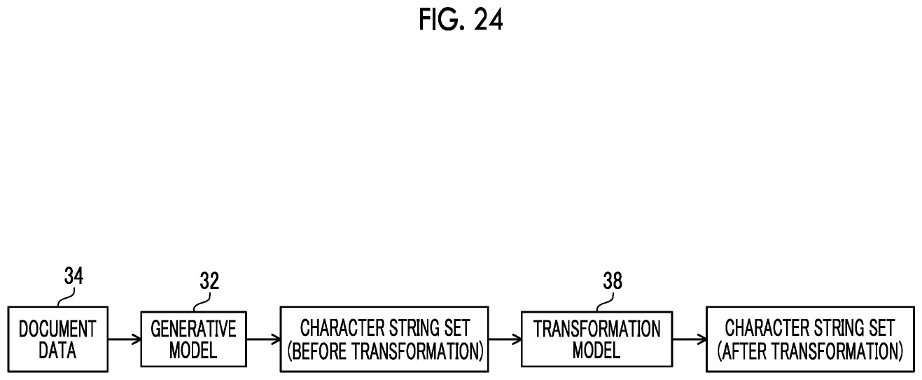

Further, in the third embodiment, as shown in FIG. 24, the output of the generative model 32 may be used as the input to the transformation model 38. The transformation model 38 is a model that receives the input of the character string set and outputs the character string set obtained by transforming the input character string set into a set of character strings in the same description format as the document data 36. The transformation model 38 is obtained by machine learning using teacher data. In this case, the derivation unit 44B derives the evaluation value of each character string constituting the character string set by using the character string set output from the transformation model 38, and the document data 36.

In each of the embodiments described above, for example, as a hardware structure of a processing unit that executes various types of processing such as each functional unit of the information processing apparatus 10, various processors shown below can be used. As described above, in addition to the CPU that is a general-purpose processor that executes software (program) to function as various processing units, the various processors include a programmable logic device (PLD) that is a processor of which a circuit configuration can be changed after manufacture, such as a field programmable gate array (FPGA), and a dedicated electric circuit that is a processor having a circuit configuration that is designed for exclusive use in order to execute specific processing, such as an application specific integrated circuit (ASIC).

One processing unit may be configured by using one of the various processors or may be configured by using a combination of two or more processors of the same type or different types (for example, a combination of a plurality of FPGAs or a combination of a CPU and an FPGA). Moreover, a plurality of processing units may be configured by using one processor.

A first example of the configuration in which the plurality of processing units are configured by using one processor is a form in which one processor is configured by using a combination of one or more CPUs and the software and this processor functions as the plurality of processing units, as represented by computers, such as a client and a server. A second example thereof is a form of using a processor that realizes the function of the entire system including the plurality of processing units by one integrated circuit (IC) chip, as represented by a system on chip (SoC) or the like. In this way, as the hardware structure, the various processing units are configured by using one or more of the various processors described above.

Further, the hardware structure of these various processors is, more specifically, an electric circuit (circuitry) in which circuit elements such as semiconductor elements are combined.

In each embodiment described above, the aspect has been described in which the information processing program 30 is stored (installed) in the storage unit 22 in advance, but the present disclosure is not limited to this. The information processing program 30 may be provided in a form of being recorded in a recording medium, such as a compact disc read only memory (CD-ROM), a digital versatile disc read only memory (DVD-ROM), and a universal serial bus (USB) memory. Moreover, the information processing program 30 may be provided in a form being downloaded from an external device via a network.

In regard to the embodiment described above, the following supplementary notes will be further disclosed.

### Supplementary Note 1

An information processing apparatus comprising: at least one processor, in which the processor acquires first document data, generates a first character string set by dividing the first document data into different lengths, derives an evaluation value of each character string constituting the first character string set by using the first character string set and second document data created from the first document data in accordance with a purpose, and selects, based on the derived evaluation value, a plurality of character strings from the first character string set as correct answer data of a generative model that receives input of document data and outputs a second character string set including a plurality of character strings included in the input document data.

### Supplementary Note 2

The information processing apparatus according to supplementary note 1, in which the processor generates a plurality of the first character string sets by dividing the first document data into different lengths from each other, and selects, based on the evaluation value, any one of the plurality of first character string sets as the correct answer data of the generative model.

### Supplementary Note 3

The information processing apparatus according to supplementary note 2, in which the processor derives a total value of the evaluation values of the character strings constituting the first character string set as the evaluation value of the first character string set, and decreases the derived evaluation value of the first character string set in accordance with at least one of a quantity of character strings, which are included in the first character string set but not included in the second document data, or a quantity of character strings, which are included in the second document data but not included in the first character string set.

### Supplementary Note 4

The information processing apparatus according to supplementary note 1, in which the processor generates one first character string set by repeating processing of dividing the first document data while varying the length of the division, and selects, based on the derived evaluation value, a plurality of character strings from the first character string set as the correct answer data of the generative model in a state in which there is no overlapping portion between the plurality of character strings.

### Supplementary Note 5

The information processing apparatus according to any one of supplementary notes 1 to 4, in which the evaluation value is a value of which evaluation is higher as a rate of match between each character string constituting the first character string set and the second document data is higher.

### Supplementary Note 6

The information processing apparatus according to any one of supplementary notes 1 to 5, in which the evaluation value is a value of which evaluation is higher as each character string constituting the first character string set is longer.

### Supplementary Note 7

The information processing apparatus according to any one of supplementary notes 1 to 6, in which the processor generates a second character string set corresponding to the first document data by inputting the first document data to the generative model, and trains the generative model so that an error between the second character string set and a plurality of character strings selected from the first character string set is minimized.

### Supplementary Note 8

An information processing method including: via a processor provided in an information processing apparatus, acquiring first document data; generating a first character string set by dividing the first document data into different lengths; deriving an evaluation value of each character string constituting the first character string set by using the first character string set and second document data created from the first document data in accordance with a purpose; and selecting, based on the derived evaluation value, a plurality of character strings from the first character string set as correct answer data of a generative model that receives input of document data and outputs a second character string set including a plurality of character strings included in the input document data.

### Supplementary Note 9

An information processing program for causing a processor provided in an information processing apparatus to execute a process including: acquiring first document data; generating a first character string set by dividing the first document data into different lengths; deriving an evaluation value of each character string constituting the first character string set by using the first character string set and second document data created from the first document data in accordance with a purpose; and selecting, based on the derived evaluation value, a plurality of character strings from the first character string set as correct answer data of a generative model that receives input of document data and outputs a second character string set including a plurality of character strings included in the input document data.

### Supplementary Note 10

An information processing apparatus comprising: at least one processor, in which the processor acquires first document data, generates a character string set corresponding to the first document data by inputting the first document data to a generative model that receives input of document data and outputs a character string set including a plurality of character strings included in the input document data, and derives an evaluation value of the character string set as a reward in a case in which the generative model is trained through reinforcement learning, by using the generated character string set and second document data created from the first document data in accordance with a purpose.

### Supplementary Note 11

The information processing apparatus according to supplementary note 10, in which the processor derives an evaluation value of each character string constituting the character string set by using the character string set and the second document data, derives a total value of the evaluation values of the character strings constituting the character string set as the evaluation value of the character string set, and decreases the derived evaluation value of the character string set in accordance with at least one of a quantity of character strings, which are included in the character string set but not included in the second document data, or a quantity of character strings, which are included in the second document data but not included in the character string set.

### Supplementary Note 12

An information processing method including: via a processor provided in an information processing apparatus, acquiring first document data; generating a character string set corresponding to the first document data by inputting the first document data to a generative model that receives input of document data and outputs a character string set including a plurality of character strings included in the input document data; and deriving an evaluation value of the character string set as a reward in a case in which the generative model is trained through reinforcement learning, by using the generated character string set and second document data created from the first document data in accordance with a purpose.

### Supplementary Note 13

An information processing program for causing a processor provided in an information processing apparatus to execute a process including: acquiring first document data; generating a character string set corresponding to the first document data by inputting the first document data to a generative model that receives input of document data and outputs a character string set including a plurality of character strings included in the input document data; and deriving an evaluation value of the character string set as a reward in a case in which the generative model is trained through reinforcement learning, by using the generated character string set and second document data created from the first document data in accordance with a purpose.

What is claimed is:

1. An information processing apparatus comprising:
at least one processor,
wherein the processor is configured to:
acquire first document data;
generate a first character string set by dividing the first document data into different lengths;
derive an evaluation value of each character string constituting the first character string set by using the first character string set and second document data created from the first document data in accordance with a purpose, and
select, based on the derived evaluation value, a plurality of character strings from the first character string set as correct answer data of a generative model that receives input of document data and outputs a second character string set including a plurality of character strings included in the input document data.

2. The information processing apparatus according to claim 1,
wherein the processor is configured to
generate a plurality of the first character string sets by dividing the first document data into different lengths from each other, and
select, based on the evaluation value, any one of the plurality of first character string sets as the correct answer data of the generative model.

3. The information processing apparatus according to claim 2,
wherein the processor is configured to
derive a total value of the evaluation values of the character strings constituting the first character string set as the evaluation value of the first character string set, and
decrease the derived evaluation value of the first character string set in accordance with at least one of a quantity of character strings, which are included in the first character string set but not included in the second document data, or a quantity of character strings, which are included in the second document data but not included in the first character string set.

4. The information processing apparatus according to claim 1,
wherein the processor is configured to
generate one first character string set by repeating processing of dividing the first document data while varying the length of the division, and
select, based on the derived evaluation value, a plurality of character strings from the first character string set as the correct answer data of the generative model in a state in which there is no overlapping portion between the plurality of character strings.

5. The information processing apparatus according to claim 1,
wherein the evaluation value is a value of which evaluation is higher as a rate of match between each character string constituting the first character string set and the second document data is higher.

6. The information processing apparatus according to claim 1,
wherein the evaluation value is a value of which evaluation is higher as each character string constituting the first character string set is longer.

7. The information processing apparatus according to claim 1,
wherein the processor is configured to
generate a second character string set corresponding to the first document data by inputting the first document data to the generative model, and
train the generative model so that an error between the second character string set and a plurality of character strings selected from the first character string set is minimized.

8. An information processing method comprising:
via a processor provided in an information processing apparatus,
acquiring first document data;
generating a first character string set by dividing the first document data into different lengths;
deriving an evaluation value of each character string constituting the first character string set by using the first character string set and second document data created from the first document data in accordance with a purpose; and
selecting, based on the derived evaluation value, a plurality of character strings from the first character string set as correct answer data of a generative model that receives input of document data and outputs a second character string set including a plurality of character strings included in the input document data.

9. A non-transitory computer-readable storage medium storing an information processing program for causing a processor provided in an information processing apparatus to execute a process comprising:
acquiring first document data;
generating a first character string set by dividing the first document data into different lengths;
deriving an evaluation value of each character string constituting the first character string set by using the first character string set and second document data created from the first document data in accordance with a purpose; and
selecting, based on the derived evaluation value, a plurality of character strings from the first character string set as correct answer data of a generative model that receives input of document data and outputs a second character string set including a plurality of character strings included in the input document data.

10. An information processing apparatus comprising:
at least one processor,
wherein the processor is configured to:
acquire first document data;
generate a character string set corresponding to the first document data by inputting the first document data to a generative model that receives input of document data and outputs a character string set including a plurality of character strings, and
derive an evaluation value of the character string set as a reward in a case in which the generative model is trained through reinforcement learning, by using the generated character string set and second document data created from the first document data in accordance with a purpose.

11. The information processing apparatus according to claim 10,
wherein the processor is configured to:
derive an evaluation value of each character string constituting the character string set by using the character string set and the second document data;
derive a total value of the evaluation values of the character strings constituting the character string set as the evaluation value of the character string set, and
decrease the derived evaluation value of the character string set in accordance with at least one of a quantity of character strings, which are included in the character string set but not included in the second document data, or a quantity of character strings, which are included in the second document data but not included in the character string set.

12. An information processing method comprising:
via a processor provided in an information processing apparatus,
acquiring first document data;
generating a character string set corresponding to the first document data by inputting the first document data to a generative model that receives input of document data and outputs a character string set including a plurality of character strings; and
deriving an evaluation value of the character string set as a reward in a case in which the generative model is trained through reinforcement learning, by using the generated character string set and second document data created from the first document data in accordance with a purpose.

13. A non-transitory computer-readable storage medium storing an information processing program for causing a processor provided in an information processing apparatus to execute a process comprising:
acquiring first document data;
generating a character string set corresponding to the first document data by inputting the first document data to a generative model that receives input of document data and outputs a character string set including a plurality of character strings; and
deriving an evaluation value of the character string set as a reward in a case in which the generative model is trained through reinforcement learning, by using the generated character string set and second document data created from the first document data in accordance with a purpose.

14. The information processing apparatus according to claim 2,
wherein the processor is configured to
generate a plurality of the first character string sets by dividing the first document data by units having certain lengths, wherein the certain lengths are different between the plurality of first character string sets.
